(19) United States
(12) Patent Application Publication
(10) Pub. No.: US 2013/0324693 A1
(43) Pub. Date: Dec. 5, 2013

(54) Polyamide Conditioning

(71) Applicant: Buhler Thermal Processes AG, Oberburen (CH)

(72) Inventors: Andreas Christel, Zuzwil (CH); Brent Allan Culbert, Wil (CH)

(21) Appl. No.: 13/910,567

(22) Filed: Jun. 5, 2013

(30) Foreign Application Priority Data
Jun. 5, 2012 (EP) 12170778.0

(51) Int. Cl. C08G 69/06

(52) U.S. Cl. CPC C08G 69/06
USPC 528/323

(57) ABSTRACT

Polyamide particles are introduced into the upper region of a reaction space and are removed from a lower region. As they fall through the reaction space, the particles are countercurrently contacted by a process gas initially having a water content of 0.8% to 20% by weight, and a temperature of 100 to 200° C. The ratio of the superficial space velocity of the process gas to the loosening velocity of the polyamide particles is in the range from 0.7 to 1.5 in the lower region. Other flow parameters are controlled such that the process gas does not condense out in the upper region of the reaction space.

The present invention relates to a process for thermal treatment of polyamides.

Polyamides are chemically resistant and have advantageous properties as a material and so are widely used, for example as fibres or in the manufacture of pipes and containers. Polyamides are typically produced from the corresponding monomers by melt polycondensation. However, this method can only be used to synthesize polyamides having a particular molecular weight, since the attempt to increase the molecular weight of the polyamide in the melt is accompanied by a simultaneous increase in the thermal degradation of the product in the melt. To obtain polyamides of higher molecular weights, polymer pellets obtained by melt polycondensation are subjected to a postcondensation in the solid phase (also known as a solid-state polycondensation (SSP) reaction).

The SSP reaction is well known for polycondensates such as polyesters or polyamides (cf. for instance Scheirs/Long (eds.): Modern Polyesters, Wiley 2003, especially pages 143-244; DE 195 10 698 A1; EP 1 981 931 B1; WO 03/062302 A1; U.S. Pat. No. 5,597,888; WO 01/39947 A1).

The polymer pellets are heated to an appropriate temperature below their melting point and the reaction equilibrium is shifted towards polyamides of higher molecular weight by removing the by-products (using for example a process gas flowing through the pellets in countercurrent).

Attempts to optimize the SSP reaction for polyamides are described in the literature. EP 1 981 931 B1 for instance proposes a procedure which is said to reduce the residence times of the polyamide pellets in the SSP reactor to reach the desired molecular weight and also the by-product fraction (monomers and oligomers, for example) in the product. The pellets are subjected to a two-step treatment. The two treatment steps differ with regard to the moisture content of the process gas used (which can be purely water vapour in the first step) and also with regard to the reaction temperatures and residence times. A moist process gas is said to provide efficient removal of undesired by-products such as oligomers in the first step, while a comparatively dry process gas is used in the second step in order that a very high increase in the molecular weight may be achieved.

The long residence time, which in the examples of EP 1 981 931 B1 is still 20-30 h taking the two steps together, continues to be a disadvantage with this procedure. Therefore, large conditioners are needed to carry out the process described in EP 1 981 931 B1 in a continuous manner.

EP 2 297 228 B1 describes a continuous process for multi-step drying and postcondensation of polyamide pellets. The process is characterized in that the process gas in the postcondensation step is introduced at two or more places along the reactor shaft (at its base and in the upper half below the surface of the pellets). This procedure is comparatively involved and predicates the use of a large amount of process gas. The polyamide pellets are introduced into the predrying step at a temperature of not less than 70° C. The problems due to low pellet temperatures and also the need for efficient drying of the polyamide pellets in the drying step go unrecognized in this document.

It is an object of the present invention to overcome the above-described disadvantages of the prior art and to provide a process for polyamide conditioning whereby the molecular weight of a polyamide can be efficiently increased to a desired value in an SSP reaction within a comparatively short time irrespective of the temperature of the polyamide in a comparatively small reactor.

This object is achieved according to the present invention by increasing the velocity (but not the overall amount) of the process gas flowing through the conditioning space in such a hereinbelow-explained coordination with the other essential processing parameters that rapid and efficient drying of the pellets to a moisture content of not more than 1% by weight is obtained. It has been determined according to the present invention that polymer pellets thus efficiently dried can be raised in a subsequent SSP step to a desired molecular weight distinctly more rapidly than in the prior art without any need for a special apparatus with multiple gas inlets as described in EP 2 297 228 B1. This is because the polyamide pellets introduced into the SSP reaction space, which have been pretreated according to the present invention, contain so little moisture that there is no condensation-based temporary drop in the temperature of the SSP reaction space. Moreover, the SSP reaction can be carried out with distinctly less process gas than known from EP 2 297 228 B1 for example.

Notably when conditioning cold polyamide pellets (i.e. pellets at room temperature for example) according to the present invention, care must be taken to ensure that the temperature of the process gas at the time of exit from the conditioning space is above the dew point of the gas. It has been determined according to the present invention that condensate separation from the process gas and the associated pressure spikes and also distortions of the residence-time spectrum can be avoided when the process gas has a velocity in the conditioner (hereinafter also referred to as the first reaction space) such that the fixed bed of polyamide particles in the reactor undergoes some loosening. In these circumstances, the heat transfer between the process gas and the polyamide is such a restricted heat transfer that the process gas exiting from the reactor still has a temperature above its dew point. Undesired condensation of water (and monomers) is thereby prevented without otherwise incurring adverse consequences for the conditioning and the optionally adjoining SSP reaction. This problem of the water in the gas condensing out—which presents at low polymer temperature in particular—with adverse repercussions for the conditioning step has hitherto gone unrecognized in the prior art.

The present invention accordingly provides a continuous process for thermally treating a polyamide, said process comprising the steps of introducing polyamide particles into the upper region of a first reaction space and removing the polyamide particles from a lower region of the first reaction space, wherein the polyamide particles gravimetrically descending through the first reaction space are countercurrently contacted with a process gas which on entry into the first reaction space has a water content of 0.8% to 20% by weight, based on the overall weight of the process gas, and also a temperature of 100 to 200° C., characterized in that the ratio of the superficial space velocity of the process gas to the loosening velocity of the polyamide particles is in the range from 0.7 to 1.5 in the lower region at least of the first reaction space and the polyamide particles are present as a loosened bed in the lower region at least of the first reaction space, and in that the ratio of the mass flow of the process gas m_{g} to the mass flow of the polyamide particles mₚ is in the range from 3.0 to 20.0, preferably in the range from 3.8 to 15.0 and more preferably in the range from 4.0 to 10.0 and the above parameters are chosen such that the process gas does not condense out in the upper region of the first reaction space.

The superficial space velocity v_{g} of a gas is defined as the gas throughput per cross-sectional area of the treatment space:

$${v}_{g} = \frac{V}{A} = \frac{m}{ρ \cdot π \cdot {r}^{2}}$$

The loosening velocity Vₗ of the polyamide particles is the flow velocity at which a bed of the polyamide particles in the first reaction space is in the state of loosest packing. Below the loosening point, the bed of polyamide particles is a fixed bed. The process gas moves at low velocity through the voids in the porous fixed bed without changing the packing structure thereof. Raising the flow velocity of the process gas brings about an increasing fluidization of the bed (i.e. loosening occurs) until at a velocity equal to the loosening velocity a state is reached where the particles of the bed are suspended in the process gas without permanent contact with each other. Details regarding determination and computation of the loosening point and of the loosening velocity are discernible from VDI-Wärmeatlas, 5th edition 1988, chapter Lf (notably image 4 for the determination via measurement of the pressure drop profile).

For a bed of pellets having an average corpuscle diameter of 1.4 to 5 mm and a temperature between 0° C. and 300° C., the loosening point is reached at a gas velocity (i.e. the loosening velocity) of about 0.6 to 2 m/s.

To achieve the invention ratio v=v_{g}/v₁ of 0.7 to 1.5 in the lower region at least of the first reaction space, the process gas, for example, needs to have a superficial space velocity of 0.42 to 0.9 m/s when the loosening speed is 0.6 m/s and of 1.4 to 3 m/s when the loosening speed is 2 m/s. The superficial space velocity Vg in the process of the present invention is preferably in the range from 0.85 to 1.3.

According to the present invention, any polyamide whose molecular weight can be increased in an SSP reaction can be used. It is preferable to use a polyamide prepolymer. But the polyamide used can also be a polyamide polymer which already has an increased molecular weight (compared with a polyamide prepolymer), for example a recyclate, i.e. a recycled polymer from a manufacturing or processing operation, or a reclaimed post-consumer polymer.

Any species of polyamides can be used according to the present invention, such as aliphatic polyamides, partly aromatic polyamides or wholly aromatic polyamides and also copolymers thereof. Aliphatic polyamides are obtainable from aliphatic or cycloaliphatic diamines by reaction with aliphatic or cycloaliphatic dicarboxylic acids, or from aliphatic α,ω-aminocarboxylic acids or lactams or mixtures thereof. Suitable (cyclo)aliphatic diamines include for example linear, branched or cyclic C2-C15 diamines such as 1,4-butanediamine, 1,6-hexamethylenediamine, 2-methyl-1,5-pentamethylenediamine, 1,9-nonanediamine, 1,11-undecanediamine, 1,12-dodecanediamine, 1,3-diaminomethylcyclohexane, 1,4-diaminomethylcyclohexane or 1,4-diaminocyclohexane.

Suitable (cyclo)aliphatic dicarboxylic acids include for example linear, branched or cyclic C4-C15 dicarboxylic acids such as adipic acid, dodecanoic acid or p-cyclohexanedicarboxylic acid.

Suitable aliphatic α,ω-aminocarboxylic acids include for example C4-12 α,ω-aminocarboxylic acids such as aminocapric acid or aminoundecanoic acid.

Suitable lactams include for example caprolactam, caprylolactam or dodecalactam.

Partly aromatic polyamides are obtainable from one of the above-described aliphatic components and an aromatic monomer such as an aromatic amine such as p-phenylenediamine or an aromatic dicarboxylic acid such as orthophthalic acid, isophthalic acid or terephthalic acid.

Wholly aromatic polyamides are obtainable from a combination of the above aromatic diamines and aromatic dicarboxylic acids.

Examples of polyamides suitable according to the present invention are nylon-4,6, nylon-6,6, nylon-6, nylon-11 or nylon-12, to name but a few.

It is preferable according to the present invention for a polyamide prepolymer to be used in the claimed process. A polyamide prepolymer is the product of polycondensing the above-described monomers which has a relative solution viscosity (sulphuric acid viscosity or SAV) in the range from 1.7 to 4, preferably in the range from 1.7 to 3 and more preferably in the range from 1.7 to 2.5. The determination of the SAV in 96% of sulphuric acid using a Ubbelohde viscometer (capillary II) at 25° C. is known to a person skilled in the art and is described in, for example, DE 195 10 698 (page 4 lines 50-56), the corresponding content of which is hereby expressly incorporated herein, or in German standard specification DIN 53 727. The SAV is the quotient formed from the viscosity of polyamide solution and the viscosity of the solvent and is a measure of the average molecular weight of the polyamide.

Polyamide prepolymers are obtainable by common practices known to a person skilled in the art, typically via a melt polycondensation or alternatively via a solution polycondensation. These polycondensation reactions are known to a person skilled in the art and are described in the literature (e.g. EP 0 254 367; Bottenbruch/Binsack (eds.), Technische Thermoplaste, 4. Polyamide, Munich 1998).

The polymers may be additized. Suitable additives include for example catalysts, dyes and pigments, UV blockers, process aids, stabilizers, impact modifiers, chemical and physical blowing agents, fillers, nucleating agents, flame retardants, plasticizers, particles to improve barrier or mechanical properties, reinforcing bodies such as spheres or fibres, and also reactive substances such as, for example, oxygen absorbers, acetaldehyde absorbers or molecular weight enhancers, etc.

The polyamide is supplied to the process of the present invention in particulate form, i.e. as pellets. Pellets for the present invention are preferably formed from a polymer melt. A polymer melt is formed using apparatuses or reactors known in the prior art. Suitable in principle are polymerization reactors wherein polymers are produced in the liquid phase, for example stirred tanks, cage reactors or disc reactors, or else machines in which previously produced polymers are melted, for example extruders or kneaders. Polymer melt production can be continuous or batchwise. Continuous operations are preferable for further processing, however.

Individual strands of polycondensate are formed from the polycondensate melt in an exit device, in particular a die or dieplate. Pellets can be produced from the polycondensate strands using prior art pelletization techniques such as strand pelletization, water-cooled die face pelletization, underwater pelletization or hot face pelletization. The polycondensate strands emerging from the melt channels are solidified and separated into a multiplicity of individual pellets, while separation can take place before or after solidification.

Notwithstanding the use of the term “water” in the designation of pelletizing equipment, other liquid media can also be used. Separation is effected for example through autogenous dropletization, through the use of a liquid shearing medium or through mechanical severing, especially cutting.

While dropletization, whether autogenous or induced by a shearing medium, takes place at the die face, cutting can take place not only directly at the die face but also after passage through a treatment sector. Solidification of the polycondensate melt is effected by cooling with one or more cooling fluids, which can be gaseous (e.g. air, nitrogen or CO₂) or liquid (e.g. water or ethylene glycol) cooling media or a combination thereof. According to the present invention, at least one liquid cooling medium is used. The polycondensate, especially as polycondensate strands or as droplets, can for example flow through a sector containing a process gas, especially air or water mist, before entry into the liquid cooling medium.

Average pellet size shall be between 0.1 mm and 10 mm, preferably between 0.5 mm and 6 mm and especially between 1.4 mm and 5 mm.

The pellets shall preferably have a defined pellet shape such as, for example, cylinder-shaped, sphere-shaped, droplet-shaped, sphere-like or a designed shape as proposed in EP 0 541 674 for example.

Before being introduced into the process of the present invention, the polycondensate pellets are brought to a temperature in the range from 10° C. to 110° C. Preferably, the pellets are brought either to room temperature or to a temperature of 80-110° C. Concurrently with the temperature adjustment, the polycondensate pellets can be conveyed into a further operation. In contradistinction to the processes from the prior art, the present invention makes it possible for polyamide pellets to be efficiently conditioned at room temperature. However, even when conditioning the polyamide pellets at higher temperature, the advantages due to the present invention will reveal themselves in a subsequent postcondensation.

After cooling, the cooling medium is separated from the pellets. Optionally, a further treatment (conditioning) of the pellets takes place in a liquid medium, wherefor directly the cooling medium or some other liquid can be used. Such a further treatment of the pellets is carried out in particular to remove low molecular weight monomers and oligomers which are unavoidably formed in the melt polymerization step and impair the processibility and also the properties of the pellets. The monomers and oligomers are removed by continuous or batchwise extraction with hot water (DE A 25 01 348, DE A 27 32 328), by distilling off in vacuo (U.S. Pat. No. 4,376,680) or in superheated steam (EP 0 284 968 B1). For reasons of environmental protection and economy, these processes are all preferably carried out with extract recovery and reuse. The use of caprolactam (DE A 43 24 616) or of aqueous aminonitrile solutions (WO 99/43407) as an extractant instead of water has also been proposed. Extraction takes place in one or more stages in an extraction tower over several hours. Extraction towers and processes of this type are well known from the prior art. An example is WO 99/43407, the pertinent content of which is hereby incorporated herein by reference.

Separating the pellets from a liquid cooling medium is effected using separating devices known in the prior art. The separating devices used may be merely passive ones, for example gratings or grids, wherethrough the cooling medium can pass but not the pellets. Typically, however, active separating devices are used for some of the separation at least, in which case separation is effected, for example, due to gas through-flow, a centrifugal force or an impact. Examples of such devices are known as aspirating devices, impact dryers or centrifugal dryers. Similarly, some of the separation can be effected using an unsaturated, optionally heated gas stream from vaporizing the cooling medium.

After the pellets of polycondensate have been removed from the liquid cooling medium, they can be directly transferred into the subsequent first reaction space. Optionally, however, the pellets of polycondensate can also be directed through a conveying sector.

Before entry into the first reaction space (conditioner), the particles have

a water content of 5% to 20% by weight and preferably of 9% to 16% by weight based on the dry weight of the particles;

a monomer content of up to 15% by weight, preferably up to 5% by weight and more preferably in the range from 0.3% to 3% by weight based on the dry weight of the particles;

a relative solution viscosity (sulphuric acid viscosity or SAV) in the range from 1.7 to 4, preferably in the range from 1.7 to 3 and more preferably in the range from 1.7 to 2.5.

The first reaction space (conditioner) of the device according to the present invention is surrounded by a housing. The horizontal cross section through the first reaction space can have any desired shape. A round or rectangular shape is preferable according to the present invention. The first reaction space is disposed substantially vertically, so the particles will flow downwardly through the space under the influence of gravity. It is important to achieve a product flux which is uniform.

The first reaction space (conditioner) of the device according to the present invention is laterally bounded by a shell. The wall of this shell can consist of conical or cylindrical segments or some combination thereof. The velocity distribution of the process gas flowing through the particles in countercurrent can be influenced via the height of the first reaction space. Widening in the ceiling region makes it possible to reduce the gas velocity and so reduce or prevent the dragout of polyamide material which is present as bed material. Narrowing in the ceiling region, on the other hand, makes it possible to raise the gas velocity, leading to greater fluidization of the material, thus preventing or reducing caking of particles.

On the inside, the first reaction space can be fitted with at least one displacer which does not have bed material flow through it and accordingly reduces the size of the first reaction space. These displacers can be used for example for routing the process gas, for adjusting the free cross-sectional area or for improving the flux of bed material. Dividing walls can further subdivide the first reaction space into two or more chambers, in which case product distribution into two or more chambers concurrently or from one chamber to the next is conceivable. At least one chamber in this embodiment constitutes the present first reaction space having the properties described therein. The partitioning into chambers can extend over the entire height of the first reaction space, over the height covered by bed material or only over part of that height of the first reaction space which is covered by bed material. The above-described chambers can be fed or operated individually or together with peripherals such as the removal means for the process gas, the discharge device, heaters, fans, etc.

The first reaction space comprises at least one feed aperture, preferably positioned in the ceiling region of the first reaction space, for introducing the polyamide material to be treated. A housing aperture or an outlet from a pipe conducted into the first reaction space can be concerned here for example. The feed aperture can be segmented to distribute the material to be introduced, or there can be two or more feed apertures which preferably receive a consistent share of the material via a distributor piece.

The first reaction space is bounded at its bottom end by a base which can be flat or taper off conically. The first reaction space has at least one discharge aperture, which is typically positioned in the basal region of the reaction space and is a housing aperture or a pipe inlet for example. It is preferable according to the present invention for the conditioned material to travel in the direction of the discharge aperture through a conically tapered region wherein the angle of the outflow cone thus formed is preferably in the range from 30 to 50°. Mechanical discharging devices such as, for example, a screw can also be provided.

The basal region of the first reaction space locates one or more feed means for the process gas which have outlet apertures wherethrough the process gas flows upwardly into the first reaction space. Feed lines can be concerned here. Sufficiently uniform distribution of the process gas must be ensured. Preference is given to a multiplicity of lines with outlet apertures via which the process gas is distributed over the cross section through the first reaction space. The feed means is typically connected directly or indirectly to lines and channels wherethrough a communication with means for pretreating the process gas, such as compressing means (fans, blowers, etc.), heat exchangers or cleaning means (such as filters, gas scrubbers, etc.), is established. In an alternative embodiment of the present invention, at least one additional gas inlet can be provided at approximately half the height of the first reaction space.

The reaction gas flows upwardly through the first reaction space in countercurrent to the bed material and departs from the first reaction space through outlet apertures in the ceiling region of the first reaction space. The outlet apertures can be removal lines. The removal lines can contain devices which permit the passage of process gas, but bar or hinder the passage of bed material, a zig-zag separator for example. The outlet aperture is typically likewise connected directly or indirectly to lines and channels wherethrough a communication with means for pretreating the process gas such as compressing means (fans, blowers, etc.), heat exchangers or cleaning means (such as filters, gas scrubbers, etc.) is established. Between the feed and removal means for the process gas is preferably a closed circuit. This circuit serves particularly to clean the process gas and readjust it to the hereinbelow-described inlet temperature.

It is preferable according to the present invention for the first reaction space to have a flat structure where the height (H) of the first reaction space and the cross-sectional area (A) in the basal region (the untapered cross-sectional area in the case of a conical outflow) form a ratio V=H²/A, where V is less than 4, preferably less than 2.

The process gas in the present invention is preferably nitrogen which on entry into the first reaction space has a moisture content of 0.8% to 20% by weight of water (corresponds to a dew point of 10 to 70° C.), preferably 0.8% to 13% by weight of water (corresponds to a dew point of 10 to 60° C.), and more preferably 1.4% to 7.8% by weight of water (corresponds to a dew point of 20 to 50° C.). The process gas preferably has a temperature of 100 to 200° C. on entry into the first reaction space. According to the present invention, the amount of process gas introduced into the first reaction space is such that the ratio of process gas amount (mg) to amount of bed material in the first reaction space (mp) mg/mp is in the range from 3.0 to 20.0, preferably in the range from 3.8 to 15.0 and more preferably in the range from 4.0 to 10.0. The process gas preferably has an oxygen content of not more than 20 ppm.

It is essential for the purposes of the present invention that the process gas has sufficient velocity on entry into the first reaction space. It is essential according to the present invention that the ratio of the superficial space velocity of the process gas to the loosening velocity of the polyamide particles is in the range from 0.7 to 1.5 in the lower region at least of the first reaction space and the polyamide particles are present as a loosened bed in the lower region at least of the first reaction space. This has already been developed at length above.

The values to be set according to the present invention (temperature of pellets, moisture content of process gas, mg/mp ratio, vg/vl ratio) are mutually dependent. When, for example, a polyamide pellet material having a low temperature (room temperature for example) is used in combination with a process gas having a comparatively high moisture content, it is accordingly necessary to use a higher amount of process gas and also increase its superficial space velocity in order that condensing out of the process gas in the upper region of the first reaction space may be avoided. This is shown in Examples and Comparative Examples 1 to 3 hereinbelow. A person skilled in the art is routinely able to readily determine the parameters which are each to be set within the ranges of the present invention.

In a preferred embodiment of the present invention, moreover, a ratio of the superficial space velocity of the process gas in the upper region of the first reaction space to the loosening velocity of the polyamide particles is in the range from 1.2 to 4 and preferably in the range from 1.5 to 3 and the polyamide particles therefore become fluidized in the upper region at least of the first reaction space. This can be achieved by providing conventional baffling elements in the upper region of the first reaction space. Upper region of the first reaction space is herein to be understood as referring to that region of the first reaction space which, when the first reaction space is hypothetically subdivided into two sections of equal size, is situated in the upper of these two sections. The lower region of the first reaction space is by analogy to be understood herein as meaning that region of the first reaction space which, when the first reaction space is hypothetically subdivided into two sections of equal size, is situated in the lower of these two sections.

This high gas velocity in conjunction with the other herein-discussed parameters in the first reaction space (moisture content of process gas, temperature of pellets, mg/mp ratio) ensures that the process gas still has a temperature above its dew point on exiting from the first reaction space. It is preferable according to the present invention for the temperature of the process gas leaving the first reaction space to be not less than 10° C. above the dew point of the gas.

According to the present invention, from 100 to 12 000 kg of bed material per hour pass through the first reaction space. The residence time of the bed material in the first reaction space is preferably in the range from 0.2 to 5 h and more preferably in the range from 0.5 to 3 h. On exit from the first reaction space, the bed material has a temperature in the range from 100 to 195° C., preferably 120 to 190° C., and also a water content of not more than 1% by weight, based on the dry weight of the bed material. The material at this point has a monomer content of up to 5% by weight, based on the dry weight of the bed material. The relative solution viscosity (SAV) of the bed material on leaving the first reaction space is in the range from 2 to 6 and preferably in the range from 2.3 to 4.

Using the process of the present invention, cold polyamide having a temperature of from 0 to about 60° C., preferably 15 to 40° C., on entry into the first reaction space as well as hot polyamide having a temperature of 60 to about 110° C. on entry into the first reaction space can be conditioned without any disadvantageous condensation of water out of the process gas.

Separation of condensate out of the process gas would result in pressure spikes and also distortions of the residence-time spectrum, since product flux and gas flux would be adversely affected and there would be high loss of gas pressure. The process of the present invention is notable in that a comparatively large amount of process gas can be led through the first reaction space without incurring any significant pressure drop. Any pressure drop in the process of the present invention is preferably less than 150 mbar, preferably less than 100 mbar.

The above-described process for treatment of polyamide can be carried out on its own. Preferably, according to the present invention, it is followed by a step for raising the molecular weight of the polyamide (SSP reaction), however.

Although it would be possible in principle to carry out the two steps in sections of the same device which are different and separated from each other (i.e. the two reaction spaces are situated in a single device), it is preferable according to the present invention to perform the second step in a distinct device. In this case, the polyamide can be transferred into the second reaction space without conveyance (i.e. by means of gravity only) via a free-fall tube. In an alternative embodiment, the polyamide on leaving the first reaction space can be transferred into the second reaction space using suitable conveying means mechanically (e.g. by means of a conveyor belt). In a further version of the present invention, conveyance can also be effected using a conveying gas. These versions are known to a person skilled in the art of the SSP reaction (conveyance from a crystallizer into an SSP reactor being an example) and need not be further elucidated here.

Before entry into the second reaction space, the polyamide material can if necessary be heated up and/or dedusted in additional means. Heating-up and dedusting assemblies are well known to a person skilled in the art (from WO 2010/094807 for example) and need not be further elucidated here.

On entry into the second reaction space, the polyamide material has a temperature in the range from 100 to 195° C. and preferably in the range from 120 to 190° C. and also a water content of not more than 1% by weight, based on the dry weight of the bed material. The material at this point has a monomer content of up to 5% by weight, based on the dry weight of the bed material. The relative solution viscosity (SAV) of the bed material on leaving the first reaction space is in the range from 2 to 6 and preferably in the range from 2.3 to 4.

The second reaction space is situated in a device of the type traditionally used for performing an SSP reaction (for polyesters or polyamides). Devices of this type are known (e.g. DE 10 2005 025 972 A1) and need not be further described herein.

The polyamide material traverses the second reaction space in a vertical downward trajectory. According to the present invention, from 100 to 12 000 kg of bed material per hour pass through the second reaction space. Within the second reaction space, the polyamide material is in the form of a fixed bed and has a residence time of 2 to 30 h, preferably 4 to 20 h, depending on the reaction conditions in the second reaction space and the targeted molecular weight. It is preferable according to the present invention for the SSP reaction to be carried out until the molecular weight of the polyamide has risen to a relative solution viscosity (SAV) of 2 to 6, preferably 2.3 to 4.0, with a minimum SAV increase of more than 0.2 especially more than 0.5.

In the second reaction space, the polyamide is treated by means of countercurrent process gas in a known manner. According to the present invention, the process gas on entry into the basal region of the second reaction space has a temperature of 10 to 200° C., preferably 20 to 195° C. It is preferable according to the present invention for nitrogen to be used as process gas having a moisture content of not more than 10% by weight of water, based on the overall weight of the process gas. Thus, the process gas on entry into the second reaction space has a dew point of −60 to +50° C. Preferably, such an amount of process gas is introduced into the second reaction space that the ratio of process gas quantity (mg) to the amount of bed material (mp) mg/mp in the second reaction space is in the range from 0.05 to 4.0, preferably below 1.5 and more preferably below 1.

The second reaction space in an alternative embodiment of the present invention can be heated with a conventional heating device to a particular temperature in order that the postcondensation process may be augmented.

The process gas preferably flows through the second reaction space at a velocity of 0.05 to 0.7 m/s.

The process gas departs the second reaction space in the ceiling region thereof. At this point it has a temperature of 10 to 200° C., preferably 50 to 195° C. The water content of the process gas at this point is 0.8% to 20% by weight, based on the overall weight of the process gas, corresponding to a dew point of 10 to 70° C. This process gas is cleaned, dried and regenerated (heated) in a known manner and can be used, again in a known manner, as process gas in the first reaction space.

It has surprisingly transpired that a polyamide pellet material which has been conditioned according to the present invention is advantageously postcondensable. More particularly, the polyamide pellet material conditioned according to the present invention has such a low moisture content (not more than 1% by weight based on the dry weight of the bed material) that no evaporation-based cooling of the pellets takes place on entry into the second reaction space in which the postcondensation takes place. The pellets conditioned according to the present invention, on the contrary, substantially retain their temperature from the conditioning step and reheat faster to the postcondensation temperature. The net result is that pellets conditioned according to the present invention need a distinctly shortened residence time in the second reaction space until the desired end-point (SAV value or water content of the polyamide) is reached. This is shown hereinbelow in the Examples and Comparative Examples 6 to 10.

In particular, because of the advantageous conditioning of the polyamide pellets there is also no need in the present invention to introduce the process gas into the second reaction space at two or more places. This results in an appreciable easing of apparatus- and process-engineering requirements compared with the teaching of EP 2 297 228 B1.

On exit from the second reaction space the product typically has a temperature in the range from 60 to 195° C. and preferably in the range from 100 to 190° C., a water content of not more than 0.5% by weight, preferably in the range from 0.01% to 0.2% by weight and especially less than 0.1% by weight, based on the dry weight of the material, and also a monomer content of not more than 1.5% by weight and preferably in the range from 0.1% to 1.3% by weight, based on the dry weight of the material. The material can if necessary be treated in a known manner, for example cooled down in a cooling means to from 20 to 120° C. and preferably from 30 to 60° C., or alternatively also be directly further processed into a desired product.

The present invention will now be more particularly elucidated with reference to non-limiting examples and FIGURE, where

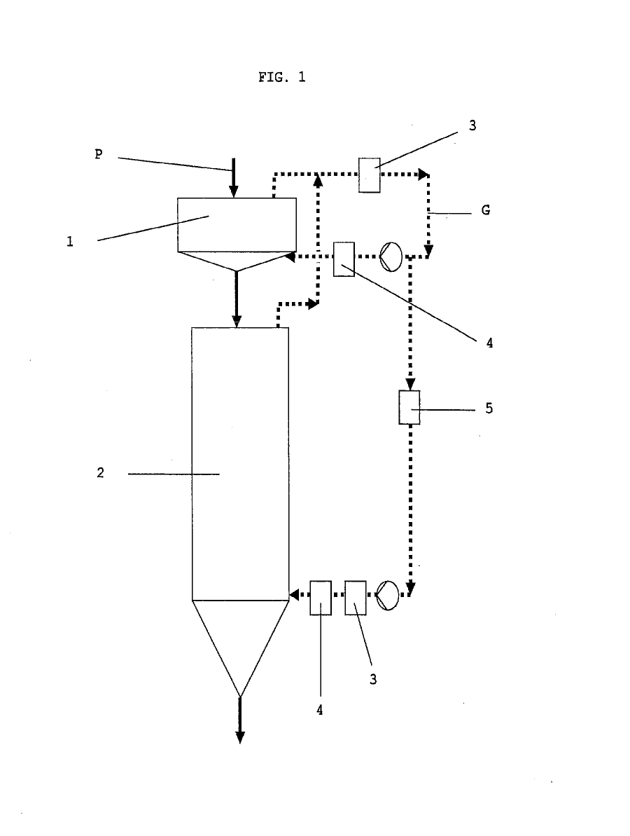

FIG. 1 shows a schematic depiction of a device which can be used according to the present invention for conditioning of polyamide.

FIG. 1 shows a device which can be used according to the present invention for conditioning of polyamide. Polyamide pellet material (P) flows, as indicated by the solid arrows in FIG. 1, through a countercurrent apparatus (1) which corresponds to the first reaction space of the present invention and in which a thermal treatment (drying) of the polyamide takes place. For this, the polyamide (P) is treated in the countercurrent apparatus (1) with a process gas (G) which is directed through the countercurrent apparatus (1) in the direction opposite to the flow direction of the polyamide (P). The flow direction of the process gas (G) is indicated by broken lines in FIG. 1. The process gas (G) enters at the lower end of the countercurrent apparatus (1) and leaves the countercurrent apparatus (1) at its upper end. The process gas (G), as shown in FIG. 1, is then preferably recycled by passing through a dust collector (3) (for example a filter or cyclone separator). Before entry into the countercurrent apparatus (1), the process gas (G) is brought to the desired temperature by means of a heating unit (4), for example a steam heater, an HTM heater or an electrical heating device, before the process gas (G) passes back into the countercurrent apparatus (1).

Countercurrent apparatuses are well known and need not be further elucidated at this juncture. According to the present invention, some other drying device can also be used instead of a countercurrent apparatus, an example being a moving-bed apparatus wherethrough the polyamide pellet material flows horizontally. The process gas typically passes through the moving-bed apparatus crosscurrently to the polyamide, entering the moving-bed apparatus through the base thereof.

The polyamide (P) leaving the drying unit, preferably the countercurrent apparatus (1), is directed into a shaft dryer (2). A further thermal treatment takes place in the shaft dryer (2) to increase the molecular weight of the polyamide. The polyamide (P) flows through the shaft dryer (2) in the downward direction. Process gas (G) passes through the shaft dryer (2) in countercurrent. In the device according to the present invention, the process gas only enters the shaft dryer (2) through an inlet tube disposed at the lower end of the shaft dryer (2) and leaves the latter at its upper end. The process gas (G), as shown in FIG. 1, is then preferably recycled by passing through a dust collector (3) (for example a filter or cyclone separator). The process gas (G) before entry into the shaft dryer (2) further passes through a cooler/water separator (5) where it is temperature-controlled, dried and cleaned by scrubbing. The process gas (G) then preferably passes through a further dust collector (3) and is brought to the desired temperature by means of a heating unit (4), for example a steam heater, HTM heater or an electric heating device, before the process gas (G) is again directed into the shaft dryer (2).

Shaft dryers are well known and need not be further elucidated here at this juncture. The present invention is not limited to the apparatus shown in FIG. 1. Other commonly used devices known to a person skilled in the art can also be used.

### EXAMPLE 1

Nylon-6 pellet material having an SAV of 2.3 and a moisture (water) content of 15.5% by weight is metered into a countercurrent dryer having a cross-sectional area (A) of 0.26 m² and a product layer height (H) of 0.9 m (V=H²/A=3.1) at the top at a throughput of 108 kg/h (dry basis) and with a temperature of 20° C. and moves vertically downward under the influence of gravity. 520 m³/h of nitrogen (at 0° C. and 1 bar) having a temperature of 165° C. and a water content of 4.9% by weight (dew point 40° C.) were introduced from below via a series of channels which ensure a uniform gas distribution and flowed upwardly through the dryer, i.e. countercurrently to the pellet material. The residence time of the pellet material in the dryer was 1.4 h. The pellet material flowed freely and departed the dryer at almost the gas inlet temperature of 165° C., an SAV of 2.4 and a final moisture (water) content of 0.30% by weight. The gas exiting from the upper region of the dryer had an outlet temperature of 57° C. and a water content of 7.3% by weight (dew point 47° C.). The superficial space velocity of the gas in the dryer was 0.89 m/s at 160° C. (gas inlet) and 0.66 m/s at 50° C. (gas outlet). At 530 m³/h the pellet material in the dryer began to slightly fluidize, which was equivalent to reaching the loosening velocity. The ratio of the superficial space velocity to the loosening velocity was 0.98. The pressure drop across the entire countercurrent apparatus was in the range from 63 to 68 mbar.

### EXAMPLE 2

Example 1 was repeated except that nylon-6 pellet material having an SAV of 2.3 and a moisture (water) content of 15.5% by weight was metered into the dryer at the top at a throughput of 96 kg/h (dry basis) and with a temperature of 20° C. and moves vertically downward under the influence of gravity. 480 m³/h of nitrogen (at 0° C. and 1 bar) having a temperature of 155° C. and a water content of 10.8% by weight (dew point 54° C.) flowed through the dryer, countercurrently to the pellet material. The residence time of the pellet material in the dryer was 1.6 h. The pellet material did not flow freely in the upper part of the dryer, since these conditions were sufficient to slightly condense water out on the pellet surface. Nonetheless, the pellet material left the dryer at almost the gas inlet temperature of 155° C., an SAV of 2.5 and a final moisture (water) content of 0.40% by weight. The gas exiting from the upper region of the dryer had an outlet temperature of 55° C. and a water content of 13.1% by weight (dew point 57° C.). The superficial space velocity of the gas in the dryer was 0.80 m/s at 155° C. (gas inlet) and 0.62 m/s at 55° C. (gas outlet). The ratio of the superficial space velocity to the loosening velocity was 0.91. The pressure drop across the entire countercurrent apparatus was in the range from 62 to 67 mbar.

### EXAMPLE 3

### Comparator

Example 1 was repeated except that nylon-6 pellet material having an SAV of 2.3 and a moisture (water) content of 15.5% by weight was metered into the dryer at the top at a throughput of 108 kg/h (dry basis) and with a temperature of 20° C. and moves vertically downward under the influence of gravity. 480 m³/h of nitrogen (at 0° C. and 1 bar) having a temperature of 155° C. and a water content of 10.8% by weight (dew point 54° C.) flowed through the dryer, countercurrently to the pellet material. The residence time of the pellet material in the dryer was 1.4 h. The pellet material did not flow freely in the first half of the dryer, since water condensed out significantly on the pellet surface. The run had to be discontinued. The gas had an outlet temperature of 50° C. and an estimated water content of about 11.4% by weight (dew point 55° C.). The superficial space velocity of the gas in the dryer was 0.80 m/s at 155° C. (gas inlet) and 0.62 m/s at 50° C. (gas outlet). The ratio of the superficial space velocity to the loosening velocity was 0.91.

It is apparent from this example that when polyamide pellet material at room temperature is conditioned with the gas having a moisture (water) content of more than 10% by weight and with an mg/mp ratio of less than 6, the ratio of the superficial space velocity to the loosening velocity (V_{g}/Vₗ) must not be below 1 if the process gas is to be stopped from condensing out in the first reaction space.

### EXAMPLE 4

### Comparator

Nylon-6 pellet material having an SAV of 2.3 and a moisture (water) content of 16% by weight was metered into a moving-bed dryer equipped with a pulsator and having a cross-sectional area of 0.3 m² and a product layer height of up to 0.2 m at a throughput of 103 kg/h (dry basis) and with a temperature of 20° C. The pellet material flowed horizontally along a perforate metal sheet wherethrough gas flowed into the dryer. An adjusting plate at the pellet outlet was used to set layer height. The pulsator steered the gas alternatingly through two halves of the perforate metal sheet to establish, in the region with gas through-flow, a gas velocity which led to the fluidization of the pellet material. 810 m³/h (at 0° C. and 1 bar) of nitrogen having a temperature of 150° C. and a water content of 10.8% by weight (dew point 54° C.) flowed through the perforate metal sheet and heated up the pellet material. Layer height and residence time were 20 cm and 0.33 h respectively. The pellet material departed the dryer with a temperature of 104° C. and a final moisture (water) content of 6.4% by weight. The superficial space velocity of the gas in the dryer was 2.32 m/s. The ratio of the superficial space velocity to the loosening velocity was 2.55.

### EXAMPLE 5

### Comparator

Example 4 was repeated except that nylon-6 pellet material having an SAV of 2.3 and also a moisture (water) content of 16% by weight was metered in at a throughput of 69 kg/h (dry basis) and a temperature of 20° C. 790 m³/h (at 0° C. and 1 bar) of nitrogen having a temperature of 170° C. and a water content of 8.6% by weight (dew point 50° C.) flowed through the perforate metal sheet and heated the pellet material up. Layer height and residence time were 14 cm and 0.33 h respectively. The pellet material departing the dryer had a temperature of 132° C. and a final moisture (water) content of 3.2% by weight. The superficial space velocity of the gas in the dryer was 2.37 m/s. The ratio of the superficial space velocity to the loosening velocity was 2.61.

Comparative Examples 4 and 5 show that efficient drying of the pellet material is impossible when the ratio of superficial space velocity to loosening velocity is too high.

### EXAMPLE 6

### Comparator

Nylon-6 pellet material (SAV 2.3, moisture content 15% by weight) was predried similarly to Example 5 above, being brought to a temperature of 122° C. and a moisture content of 3.0% by weight. The SAV at this stage was 2.4. The pellet material was subsequently treated with countercurrent gas in a shaft dryer. The shaft dryer had a diameter of 0.43 m, a layer height of 4.4 m and only one gas inlet at the very bottom of the shaft dryer. The pellet material entered the shaft dryer at a throughput of 40 kg/h (dry basis) and was further treated with 108 m³/h of nitrogen having a temperature of 140° C. and a water content of 2.7% by weight (dew point 30° C.) for 12.5 h. On entry into the shaft dryer the pellet temperature fell to about 105° C. as a result of the residual water content evaporating, before gradually heating back up to the gas inlet temperature of 140° C. in the course of about 5.5 h. The product temperature thus took about 2.3 m (H/D of 5.4) to rise to the gas inlet temperature at a mass ratio of 3.4. The temperature drop in the shaft leads to a slowdown in the SAV increase and drying. On leaving the dryer the pellet material had an SAV of 2.6 and a final moisture content of 0.06% by weight.

### EXAMPLE 7

### Comparator

Example 6 above was repeated except that the nylon-6 pellet material (SAV 2.3, moisture content 15% by weight) was brought to a moisture content of 4.0% by weight as well as a temperature of 122° C. on predrying similarly to Example 5 above. The SAV at this stage was 2.4. The pellet material entered the shaft dryer at a throughput of 45 kg/h (dry basis) and was further treated with 95 m³/h of nitrogen having a temperature of 140° C. and a water content of 2.7% by weight (dew point 30° C.) for 11 h. On entry into the shaft dryer the pellet temperature fell to about 68° C. as a result of the residual water content evaporating, before gradually heating back up to the gas inlet temperature of 140° C. in the course of about 9.6 h. The product temperature thus took about 4.6 m (H/D of 11) to rise to the gas inlet temperature at a mass ratio of 2.6. The temperature drop in the shaft leads to a slowdown in the SAV increase and drying. On leaving the dryer the pellet material had an SAV of 2.5 and a final moisture content of 0.07% by weight.

### EXAMPLE 8

Nylon-6 pellet material was predried similarly to Example 1 above, being brought to a temperature of 122° C. and a moisture content of 1.0% by weight. The pellet material entered the shaft dryer at a throughput of 40 kg/h (dry basis) and was further treated with 108 m³/h of nitrogen having a temperature of 140° C. and a water content of 2.7% by weight (dew point 30° C.) for 9 h. On entry into the shaft dryer the pellet temperature fell to about 118° C. as a result of the evaporation of the residual water content before then gradually heating back up to the gas inlet temperature of 140° C. in the course of about 4 h. The product temperature thus took about 1.7 m (H/D of 3.9) to rise to the gas inlet temperature at a mass ratio of 3.4. The pellet material leaving the dryer had a final moisture content of 0.06% by weight.

Due to the more efficient pretreatment of the polyamide (lower moisture content), distinctly less cooling of the pellet material on entry into the shaft dryer occurred. The treatment was accordingly complete after a distinctly shorter time (9 h instead of 11 h and 12.5 h in Examples 6 and 7 respectively).

### EXAMPLE 9

Nylon-6 pellet material was predried similarly to Example 1 above, being brought to a temperature of 122° C. and a moisture content of 0.5% by weight. The pellet material entered the shaft dryer at a throughput of 40 kg/h (dry basis) and was further treated with 108 m³/h of nitrogen having a temperature of 140° C. and a water content of 2.7% by weight (dew point 30° C.) for 7 h. On entry into the shaft dryer no temperature drop occurred at all. On the contrary, the pellet material gradually warmed up to the gas inlet temperature of 140° C. in the course of a period of 2 h. The product temperature thus took about 0.8 m (H/D of 2) to rise to the gas inlet temperature at a mass ratio of 3.4. The pellet material leaving the dryer had a final moisture content of 0.06% by weight.

Due to the more efficient pretreatment of the polyamide (lower moisture content), no cooling of the pellet material on entry into the shaft dryer occurred. The treatment was accordingly complete after a distinctly shorter time (7 h instead of 11 h and 12.5 h in Examples 6 and 7 respectively).

### EXAMPLE 10

### Comparator

Nylon-6 pellet material having a water content of 12.5% by weight and a temperature of 95° C. was pretreated in a moving bed at a throughput of 5.3 t/h (dry basis). The pellet material had a water content of 6.0% by weight and a temperature of 110° C. when subsequently falling into a shaft dryer. The shaft dryer had a diameter of 4.2 m and two gas inlets: one gas inlet was positioned 12 m below the surface of the bed of material (H/D=2.85, residence time about 20 h). A further gas inlet was positioned in the cone 9 m below the second cone (residence time 15 h). The upper gas inlet admitted about 200 m³/min of N₂ at 120° C. and a water content of about 3.7% by weight (dew point 35° C.). The second, lower gas inlet admitted 70 m³/min at 120° C. and a water content of about 0.75% by weight (dew point 10° C.). The pressure drop across the bed was 250 mbar in the uppermost part and about 50 mbar in the lowermost part. On entry into the shaft dryer the temperature of the pellet material fell to about 60° C. as a result of the residual water content evaporating, before climbing back up to the gas inlet temperature of 120° C. in the course of 13 h. The product moisture content was about 0.14% by weight downstream of the uppermost part. On leaving the dryer the pellet material had a final moisture content of 0.05% by weight.

### EXAMPLE 11

The nylon-6 pellet material used according to Example 10 was treated in a countercurrent apparatus having a cross-sectional area of 14 m² and a product layer height of 1.0 m (V=0.07). The pellet material was treated in the countercurrent apparatus with 480 m³/min of N₂ having a temperature of 130° C. and a water content of about 3.7% by weight (dew point 35° C.) in the course of a residence time of 1.7 h. The superficial space velocity was 0.8 m/s. The pellet material departed the countercurrent apparatus at a temperature of almost 130° C. and a moisture content of 0.75% by weight. The pressure drop across the bed was about 80 mbar.

The pellet material was then introduced into a shaft dryer of 2.0 m diameter, 15 m cylindrical height (residence time 13 h) with a gas inlet in the cone. The pellet material was dried with 32 m³/min of N₂ having a temperature of 120° C. and a water content of about 3.7% by weight (dew point 35° C.). The pellet temperature decreased gradually from 130° C. to about 120° C. On leaving the shaft dryer the pellet material had a final moisture content of 0.05% by weight.

Due to the more efficient pretreatment of the polyamide (lower moisture content), virtually no cooling of the pellet material on entry into the shaft dryer occurred. The treatment was accordingly complete after a distinctly shorter time (13 h instead of 20 h in Example 10). The elevated temperature during the treatment stage, moreover, made it possible to effect a significant reduction in the amount of gas required.

### EXAMPLE 12

Nylon-6 pellet material having a moisture content of 15.0% by weight was introduced into the countercurrent dryer of Example 1 at a throughput of 40 kg/h (dry basis) and a temperature of 30° C. 480 m³/h (at 0° C. and 1 bar) of nitrogen having a temperature of 130° C. and a water content of 2.7% by weight (dew point 30° C.) heated the pellet material up. Bed height and residence time were 0.4 m and 1.6 h respectively. The pellet material flowed freely in the countercurrent dryer and departed the dryer at a temperature of 130° C. and a final moisture content of 1.0% by weight. The gas had an outlet temperature of 94° C. and a water content of 3.6% by weight (dew point 35° C.). The superficial space velocity was 0.8 m/s at 130° C. (gas inlet). The pressure drop across the entire countercurrent apparatus was about 40 mbar.

The pellet material subsequently fell into a shaft dryer having a diameter of 0.43 m and was further treated therein with 19 m³/h of nitrogen having a temperature of 110° C. and a water content of 2.7% by weight (dew point 10° C.) for 10 h. On entry into the shaft the pellet temperature gradually sank to 112° C. The gas was fed into the shaft cone. On leaving the dryer the pellet material had a final moisture content of 0.09% by weight. The shaft dryer was equipped with electrical trace heating to compensate the loss of heat which occurs.

### EXAMPLE 13

Nylon-6 pellet material having a moisture content of 15.0% by weight was introduced into the countercurrent dryer of Example 1 at a throughput of 40 kg/h (dry basis) and a temperature of 30° C. 480 m³/h (at 0° C. and 1 bar) of nitrogen having a temperature of 115° C. and a water content of 2.7% by weight (dew point 30° C.) heated the pellet material up. Bed height and residence time were 0.7 m and 2.8 h respectively. The pellet material flowed freely in the countercurrent dryer and departed the dryer at almost the gas inlet temperature of 115° C. and a final moisture content of 1.0% by weight. The gas had an outlet temperature of 85° C. and a water content of 3.6% by weight (dew point 35° C.). The superficial space velocity was 0.76 m/s at 115° C. (gas inlet). The pressure drop across the entire countercurrent apparatus was about 65 mbar.

The pellet material subsequently fell into a shaft dryer having a diameter of 0.43 m and was further treated therein with 19 m³/h of nitrogen having a temperature of 110° C. and a water content of 2.7% by weight (dew point 10° C.) for 10 h. On entry into the shaft the pellet temperature gradually sank to 98° C. The gas was fed into the shaft cone. On leaving the dryer the pellet material had a final moisture content of 0.19% by weight. The shaft dryer was equipped with electrical trace heating to compensate the loss of heat which occurs.

### EXAMPLE 14

Nylon-6 pellet material having a moisture content of 15.0% by weight was introduced into the countercurrent dryer of Example 1 at a throughput of 60 kg/h (dry basis) and a temperature of 30° C. 450 m³/h (at 0° C. and 1 bar) of nitrogen having a temperature of 130° C. and a water content of 8.6% by weight (dew point 50° C.) heated the pellet material up. Bed height and residence time were 0.4 m and 1.0 h respectively. The pellet material flowed freely in the countercurrent dryer and departed the dryer at a temperature of 129° C. and a final moisture content of 1.0% by weight. The gas had an outlet temperature of 80° C. and a water content of 10.0% by weight (dew point 53° C.). The superficial space velocity was 0.70 m/s at 130° C. (gas inlet). The pressure drop across the entire countercurrent apparatus was about 40 mbar.

The pellet material subsequently fell into a shaft dryer having a diameter of 0.43 m and was further treated therein with 19 m³/h of nitrogen having a temperature of 110° C. and a water content of 2.7% by weight (dew point 10° C.) for 10 h. On entry into the shaft the pellet temperature gradually sank to 96° C. The gas was fed into the shaft cone. On leaving the dryer the pellet material had a final moisture content of 0.4% by weight. The shaft dryer was equipped with electrical trace heating to compensate the loss of heat which occurs.

1. Continuous process for thermally treating a polyamide, said process comprising the steps of introducing polyamide particles into the upper region of a first reaction space and removing the polyamide particles from a lower region of the first reaction space, wherein the polyamide particles gravimetrically descending through the first reaction space are countercurrently contacted with a process gas which on entry into the first reaction space has a water content of 0.8% to 20% by weight, based on the overall weight of the process gas, and also a temperature of 100 to 200° C., wherein the ratio of the superficial space velocity of the process gas to the loosening velocity of the polyamide particles is in the range from 0.7 to 1.5 in the lower region at least of the first reaction space and the polyamide particles are present as a loosened bed in the lower region at least of the first reaction space, and in that the ratio of the mass flow of the process gas mg to the mass flow of the polyamide particles mp is in the range from 3.0 to 20.0, and the above parameters are chosen such that the process gas does not condense out in the upper region of the first reaction space.

2. Process according to claim 1, wherein the polyamide particles leaving the first reaction space are directed into a second reaction space where they are contacted with a process gas in countercurrent so that the relative solution viscosity (SAV) of the polyamide particles leaving the second reaction space is in a range from 2 to 6, and has risen in the second reaction space by at least a value greater than 0.2.

3. Process according to claim 2, wherein the first and second reaction spaces are different regions of the same reactor.

4. Process according to claim 2, wherein the first and second reaction spaces are disposed in different reactors.

5. Process according to claim 1, wherein the polyamide particles entering the first reaction space have a monomer content of 0.3% to 15% by weight, based on the dry weight of the polyamide.

6. Process according to claim 1, wherein the polyamide particles entering the first reaction space have a water content of 5% to 20% by weight, based on the dry weight of the polyamide.

7. Process according to claim 1, wherein the ratio of the superficial space velocity of the process gas in the upper region of the first reaction space to the loosening velocity of the polyamide particles is in the range from 1.2 to 4 and the polyamide particles become fluidized in the upper region at least of the first reaction space.

8. Process according to claim 1, wherein the residence time of the polyamide particles in the first reaction space is in the range from 0.5 to 5 h.

9. Process according to claim 1, wherein the residence time of the polyamide particles in the second reaction space is in the range from 2 to 30 h.

10. Process according to claim 1, wherein the temperature of the polyamide particles on entry to the first reaction space is in the range from 10° C. to 110° C.

11. Process according to claim 1, wherein the process gas is nitrogen.

12. Process according to claim 1, wherein the second reaction space is additionally heated by means of a heating device.

13. Process according to claim 1, wherein the pellet material entering the second reaction space has a moisture content of not more than 1% by weight based on the dry weight of the bed material.

14. Process according to claim 1, wherein a pressure drop of less than 150 mbar occurs in the first reaction space.

15. Process according to claim 1, wherein the ratio of process gas quantity (mg) to the amount of bed material (mp) mg/mp in the second reaction space is in the range from 0.05 to 4.0.
